(19) United States
(12) Patent Application Publication
(10) Pub. No.: US 2021/0169203 A1
(43) Pub. Date: Jun. 10, 2021

(54) SHOULDER BAG WITH INTEGRATED USB CHARGER

(71) Applicant: MagnoGrip Inc., Miami, FL (US)

(72) Inventor: Andre A. Woolery, Miami, FL (US)

(73) Assignee: MagnoGrip Inc.

(21) Appl. No.: 17/109,917

(22) Filed: Dec. 2, 2020

Related U.S. Application Data
(60) Provisional application No. 62/943,866, filed on Dec. 5, 2019.

(51) Int. Cl. A45F 3/04; H02J 7/00; H02J 7/35

(52) U.S. Cl. CPC A45F 3/04; A45F 2003/003; H02J 7/35; H02J 7/0045

(57) ABSTRACT

A bag comprises a body comprising an interior accessible from one or more of a top side a bottom side, a right side and a left side. One or more shoulder straps coupled to the body enable a user to carry the bag and its contents. A USB charging port integrated into one of the one or more shoulder straps is used to charge an electronic device while carrying the bag and using the one or more shoulder straps. The electronic device is able to be charged by a power bank connected to the USB charging port through a USB cable. In some embodiments, the one or more shoulder straps are removable from the shoulder bag.

### RELATED APPLICATIONS

This patent application claims priority under 35 U.S.C. 119(e) of the co-pending U.S. provisional patent application, Application No. 62/943,866, filed on Dec. 5, 2019, and entitled “SHOULDER BAG WITH INTEGRATED USB CHARGER,” which is also hereby incorporated by reference in its entirety.

### FIELD OF THE INVENTION

The present invention relates to wearable bags and carrying devices with straps. More specifically, the invention relates to a carryable bag system, and device with an integrated USB charger.

### BACKGROUND OF THE INVENTION

Portable chargers such as power banks charge an electronic device by connecting to the power bank with a USB cable. A power bank or other portable charger enables a user to charge the electronic device when away from home or in a place without a power outlet. However, often when charging and connected to the power bank or portable charger, the electronic device must be placed in a location where it is not accessible and is unusable.

### SUMMARY OF THE INVENTION

A bag comprises a body comprising an interior accessible from one or more of a top side a bottom side, a right side and a left side. One or more shoulder straps coupled to the body enable a user to carry the bag and its contents. A USB charging port integrated into one of the one or more shoulder straps is used to charge an electronic device while carrying the bag and using the one or more shoulder straps. The electronic device is able to be charged by a power bank connected to the USB charging port through a USB cable. In some embodiments, the one or more shoulder straps are removable from the shoulder bag.

In one aspect, a wearable shoulder bag comprises a body comprising a top side, a bottom side, a right side and a left side, wherein the body is openable from one or more of the top side, the bottom side, the right side and the left side, one or more shoulder straps coupled to the body and configured to be worn on a shoulder of a user, a USB charging port for receiving a USB cable integrated within one of the one or more shoulder straps and a power bank connected to the USB charging port and for charging an electronic device coupled to the USB charging port through a USB cable. In some embodiments, the shoulder bag comprises a back pack. In some embodiments, the power bank is located within one of the one or more shoulder straps. In some embodiments, the power bank is located within the body of the wearable shoulder bag. In some embodiments, the power bank is removable.

In another aspect, a wearable bag comprises a body comprising a top side, a bottom side, a right side and a left side, wherein the body is openable from one or more of the top side, the bottom side, the right side and the left side and a power bank integrated within the body, the power bank configured for charging an electronic device. In some embodiments, the wearable bag comprises a back pack. In some embodiments, the power bank is located within a shoulder strap of the wearable bag. In further embodiments, the power bank is removable. In some embodiments, the power bank is located within a pocket of the body. In some embodiments, the body comprises one or more of a tool pocket and chain webbing for holding one or more tools. In some embodiments, the power bank removably couples with a charging cord for charging the electronic device. In further embodiments, the power bank is charged by removably coupling a power cord to an inlet port of the power bank. In some embodiments, the wearable bag comprises a solar panel for charging the power bank.

In a further aspect, a shoulder strap for a wearable bag comprises a shoulder strap body and a power bank integrated within the shoulder strap body, the power bank configured for charging an electronic device. In some embodiments, the shoulder strap comprises a USB charging port for charging an electronic device through a USB cable. In some embodiments, the power bank is located within a pocket of the shoulder strap and connects to the USB charging port through interior circuitry of the body. In some embodiments, the power bank is removable from the pocket of the shoulder strap. In further embodiments, the power bank is sewed into the shoulder strap and is recharged while coupled within the shoulder strap. In some embodiments, the shoulder strap removably couples with a wearable shoulder bag.

### BRIEF DESCRIPTION OF THE FIGURES

FIG. 1 illustrates a wearable shoulder bag with an integrated USB charger in accordance with some embodiments.

FIG. 2 illustrates a wearable shoulder bag with an integrated USB charger in accordance with some embodiments.

FIG. 3 illustrates a wearable shoulder bag with an integrated USB charger in accordance with some embodiments.

FIG. 4 illustrates a wearable shoulder bag with an integrated USB charger in accordance with some embodiments.

FIG. 5 illustrates a strap for a wearable shoulder bag with an integrated USB charger in accordance with some embodiments.

FIG. 6 illustrates a power bank for a wearable shoulder bag with an integrated USB charger in accordance with some embodiments.

FIG. 7 illustrates a wearable shoulder bag with an integrated USB charger in accordance with some embodiments.

### DETAILED DESCRIPTION OF THE EMBODIMENTS

Reference will now be made in detail to implementations of a shoulder bag with an integrated USB charger. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Embodiments of the presently claimed invention are directed to a bag comprising a body comprising an interior accessible from one or more of a top side, a bottom side, a right side and a left side. One or more shoulder straps coupled to the body enable a user to carry the bag and its contents. A USB charging port integrated into one of the one or more shoulder straps is used to charge an electronic device while carrying the bag and using the one or more shoulder straps. The electronic device is able to be charged by a power bank connected to the USB charging port through a USB cable. In some embodiments, the one or more shoulder straps are removable from the shoulder bag.

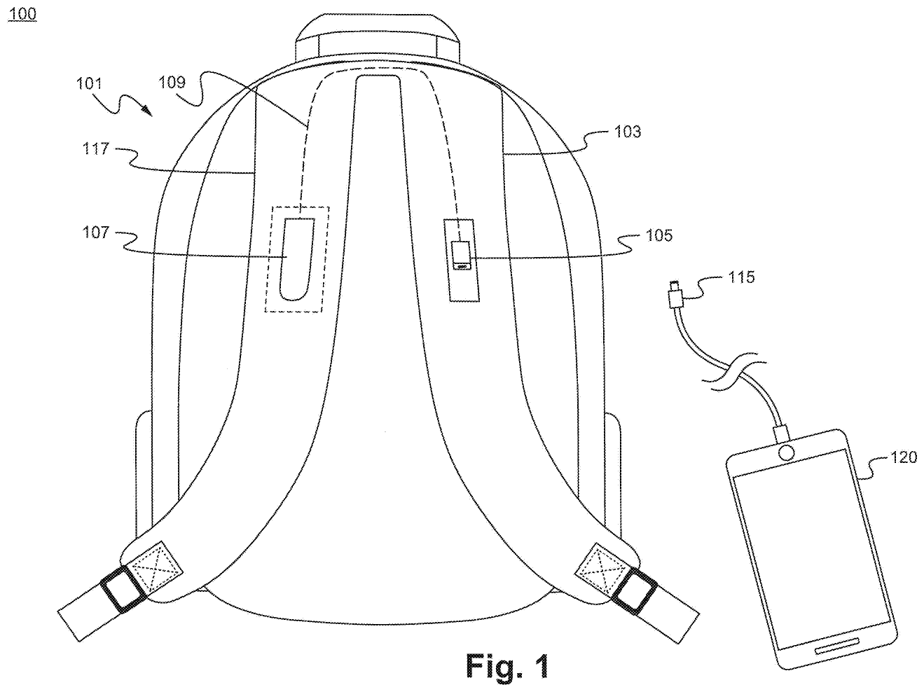

Referring now to FIG. 1, a wearable shoulder bag comprising an integrated USB charging port is depicted therein. The wearable shoulder bag 100 comprises a body 101 comprising a top side, a bottom side, a right side and a left side. The body 101 is openable from one or more of the top side, the bottom side, the right side and the left side. One or more shoulder straps 103 are configured to be worn on a shoulder of user to carry the shoulder bag 100.

As shown within FIG. 1, a USB charging port 105 is integrated into one or more of the shoulder straps 103. In some embodiments, the USB charging port 105 comprises a cover for covering the USB charging port 105 when it is not being used. A power bank 107 connects to the USB charging port 105 for charging an electronic device 120 through a USB cable 115. In some embodiments, the power bank 107 is located within a pocket 117 of one of the one or more shoulder straps 103 and connects to the USB charging port 105 through interior circuitry 109 of the body 101. In this configuration, the electronic device 120 is able to be recharged while the bag 100 is being worn by a user and the electronic device 120 is held and/or is being used by the user. The electronic device 120 is also able to be kept in a convenient and accessible location while being charged.

In some embodiments, the power bank 107 is removable from the pocket 117 of the body 101. Alternatively, in some embodiments, the power bank 107 is sewed into a shoulder strap 103 of the bag 100 and is recharged while coupled within the shoulder strap 103. In some embodiments, the power bank 107 is able to located within the body 101 and or/a pocket of the body 101.

As shown within FIG. 1, in some embodiments, the wearable shoulder bag 100 comprises a backpack. However, the bag 100 is able to comprise an appropriately desired bag 100 capable of being carried by one or more shoulder straps.

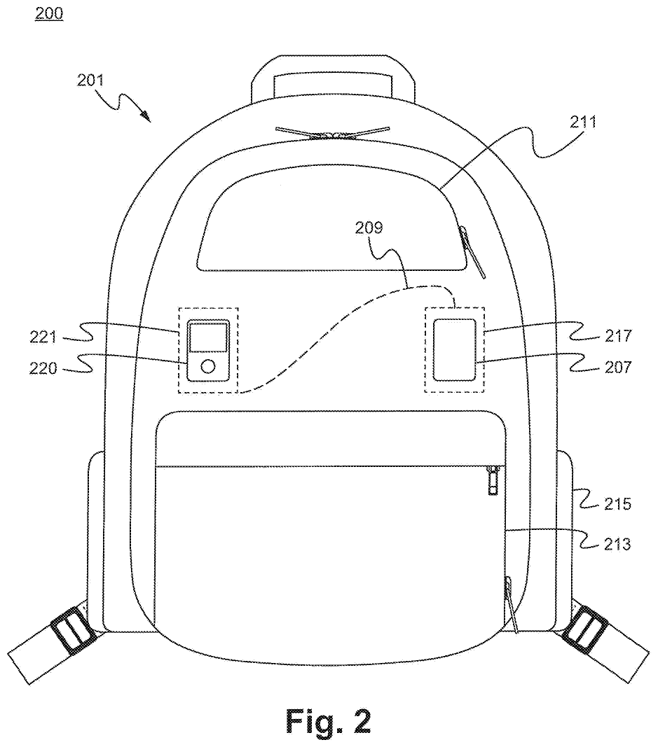

FIG. 2 illustrates a front view of a wearable shoulder bag comprising an integrated USB charging port, such as described above. As described in relation to FIG. 1, the wearable shoulder bag 200 comprises a body 201 comprising a top side, a bottom side, a right side and a left side. The body 201 is openable from one or more of the top side, the bottom side, the right side and the left side. One or more shoulder straps are configured to be worn on a shoulder of user to carry the shoulder bag 200.

As shown within FIG. 2, a USB charging port is integrated into an interior pocket 221 of the body 201. In some embodiments, an electronic device 220 is able to be charged through the USB charging port while the electronic device is held within the interior pocket 221 of the body 201. A power bank 207 connects to the USB charging port for charging the electronic device 220. In some embodiments, the power bank 207 is located within an interior pocket 217 of the body 201 and connects to the USB charging port through interior circuitry 209 of the body 201. Alternatively, in some embodiments, the power bank 207 is located within one or more shoulder straps of the bag 200, such as described above.

In some embodiments, the body 201 comprises one or more external pockets 211, 213 and 215. Particularly, the body 201 is able to comprise any appropriately desired number of external and/or internal pockets as desired. In some embodiments, the one or more external pockets 211, 213 and 215 comprises pockets for carrying tools. However, the pockets of the body are able to carry any appropriately desired items.

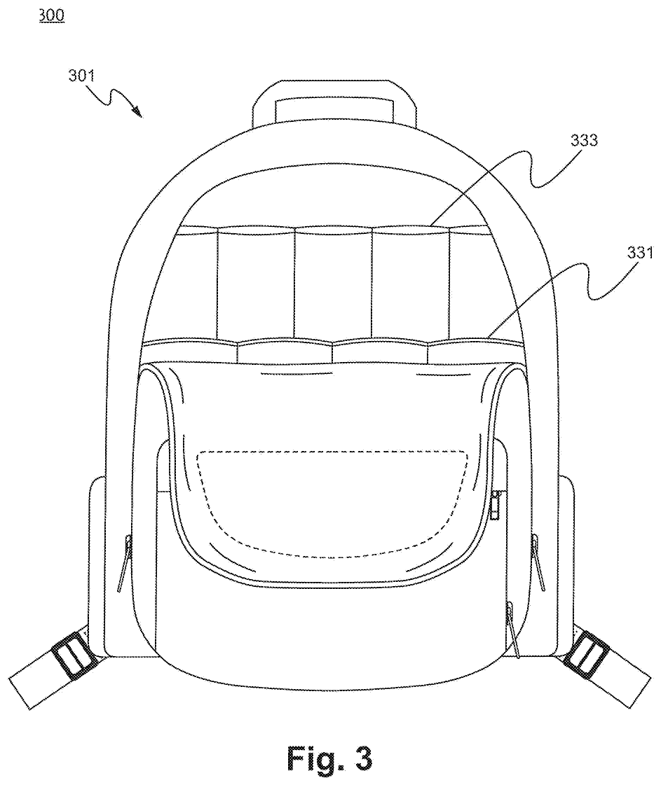

FIG. 3 illustrates a wearable shoulder bag with an integrated USB charger in an open configuration. As shown within FIG. 3, the body 301 of the shoulder bag 300 comprises one or more internal pockets 331 and chain webbing 333. In some embodiments, the one or more internal pockets 331 and chain webbing 333 are configured to hold one or more tools. However, the one or more internal pockets 331 and chain webbing 333 is able to hold any appropriately desired items. Particularly, the shoulder bag 300 is able to comprise any appropriately desired amount and configuration of pockets. For example, in some embodiments, the shoulder bag 300 comprises a tablet and/or a protective computer sleeve.

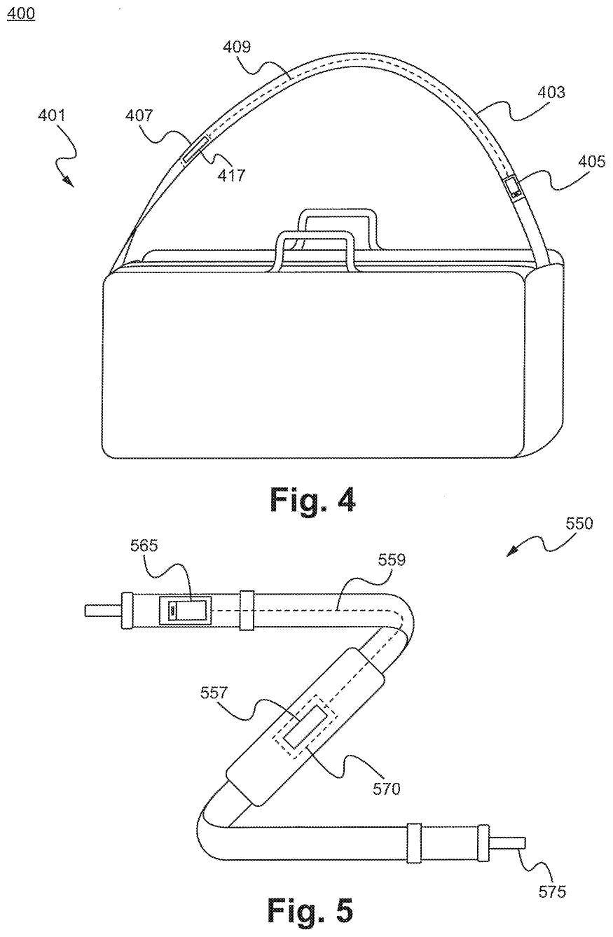

FIG. 4 illustrates a wearable shoulder bag comprising an integrated USB charging port in accordance with further embodiments. The wearable shoulder bag 400 comprises a body 401 comprising a top side, a bottom side, a right side and a left side. The body 401 is openable from one or more of the top side, the bottom side, the right side and the left side. One or more shoulder straps 403 are configured to be worn on a shoulder of user to carry the shoulder bag 400.

As further shown within FIG. 4, a USB charging port 405 is integrated into the shoulder strap 403. In some embodiments, the USB charging port 405 comprises a cover for covering the USB charging port 405 when it is not being used. As described above, a power bank 407 connects to the USB charging port 405 for charging an electronic device through a USB cable. In some embodiments, the power bank 407 is located within a pocket 417 of one of the shoulder straps 403 and connects to the USB charging port 405 through interior circuitry 409 of the body 401. In this configuration, the electronic device is able to be recharged while the bag 400 is being worn by a user and the electronic device is held and/or is being used by the user. The electronic device is able to be kept in a convenient and accessible location while being charged.

In some embodiments, the power bank 407 is removable from the pocket 417 of the body 401. Alternatively, in some embodiments, the power bank 407 is sewed into a shoulder strap 403 of the bag 400 and is recharged while coupled within the shoulder strap 403. In some embodiments, the power bank 407 is able to be located within the body 401 and or/a pocket of the body 401, such as described above.

As shown within FIG. 4, in some embodiments, the wearable shoulder bag 400 comprises a briefcase or a bag with a single shoulder strap 403. However, as described above, the bag 400 is able to comprise an appropriately desired bag 400 capable of being carried by one or more shoulder straps.

FIG. 5 illustrates a strap for a wearable shoulder bag with an integrated USB charger. The strap 550 such as shown within FIG. 5 is able to be attached to any appropriately desired bag.

As shown within FIG. 5, the strap 550 comprises a USB charging port 565 that is integrated the shoulder strap 550. In some embodiments, the USB charging port 565 comprises a cover for covering the USB charging port 565 when it is not being used. As described above, a power bank 557 connects to the USB charging port 565 for charging an electronic device through a USB cable. In some embodiments, the power bank 557 is located within a pocket 570 of the shoulder strap 550 and connects to the USB charging port 555 through interior circuitry 559 of the body 550. In some embodiments, the power bank 557 is removable from the pocket 570 of the body 550. Alternatively, in some embodiments, the power bank 557 is sewed into the shoulder strap 550 and is recharged while coupled within the shoulder strap 550. In come embodiments, one or more connectors 565 enable the shoulder strap 550 to removably couple with a desired bag.

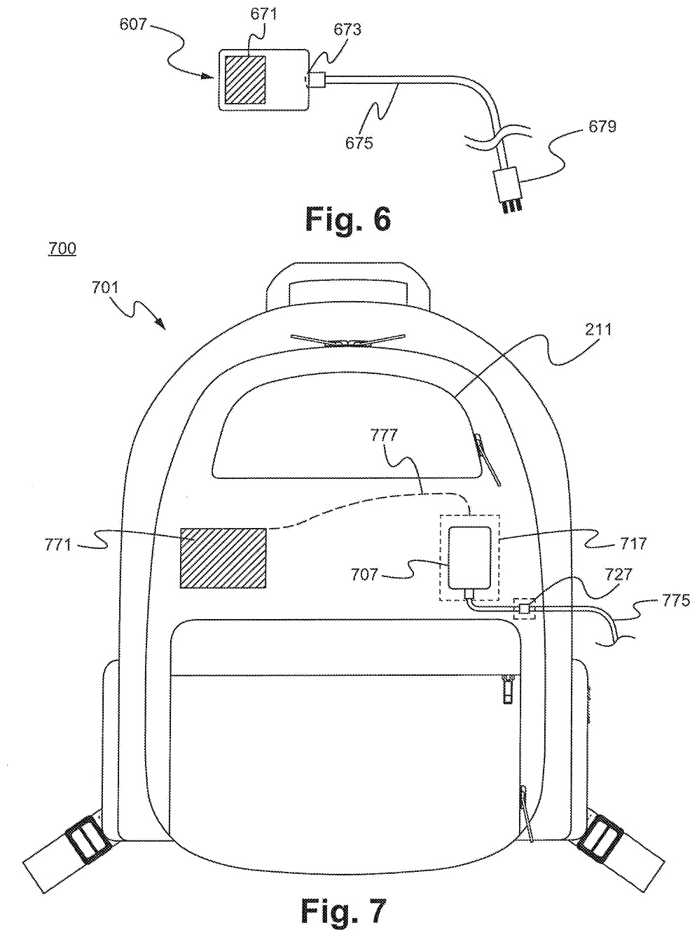

FIG. 6 illustrates a power bank 607 for charging an electronic device connected to a USB charging port through a USB cable, such as described above. In some embodiments, the power bank 607 is charged by connecting the power bank 607 to a power outlet. In some embodiments, the power bank 607 is charged by removably coupling a power cord 675 to an inlet port 673 of the power bank 607. In some embodiments, the power cord 675 comprises a three prong plug 679 for plugging into a power outlet. However, the power cord 675 is able to comprise any appropriately desired power cord for charging the power bank 607. For example, in some embodiments, the power cord 675 comprises a USB cable or other power cable. In some embodiments, such as shown within FIG. 6, the power bank 607 comprises a solar panel 671 for charging the power bank 607.

As described above, in some embodiments, the power bank 607 is removable from the body and/or a shoulder strap of a wearable bag to charge the power bank 607. Alternatively, in some embodiments, the power bank 607 is charged while sewed into the body and/or a shoulder strap of a wearable bag. As described above, a charged power bank is able to connect to a USB charging port for charging an electronic device through a USB cable.

FIG. 7 illustrates a wearable shoulder bag comprising an integrated USB charging port, such as described above. As shown within FIG. 7, a power bank 707 is located within an interior pocket 717 of the body 701. Alternatively, in some embodiments, the power bank 707 is located within one or more shoulder straps of the bag 700, such as described above. As shown within FIG. 7, in some embodiments, a flap 727 or openable pocket enables a power cord 775 to couple with the power bank 707 to charge the power bank 707 while it is located within the body 701 or a strap of the bag 700. Alternatively or in conjunction, a solar panel 771 of the bag 700 is used to charge the power bank 707. In some embodiments, interior circuitry 777 of the body 701 is able to connect the solar panel 771 with the power bank 707 for charging the power bank 707. As described above, a charged power bank is able to connect to a USB charging port for charging an electronic device through a USB cable.

In operation, a wearable bag is able to comprise one or more shoulder straps coupled to the bag and comprising a USB charging port integrated into one of the one or more shoulder straps that is used to charge an electronic device while carrying the bag and using the one or more shoulder straps. The electronic device is able to be charged by a power bank connected to the USB charging port through a USB cable. In some embodiments, the shoulder strap is removable from the shoulder bag. By placing the charging port in a convenient location away from a power source, the electronic device is able to be used while it is charging. The electronic device is able to be kept in a convenient and accessible location while being charged. As such, the shoulder bag and strap with an integrated USB charger as described herein have many advantages.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiments chosen for illustration without departing from the spirit and scope of the invention

We claim:

1. A wearable shoulder bag comprising:
a. a body comprising a top side, a bottom side, a right side and a left side, wherein the body is openable from one or more of the top side, the bottom side, the right side and the left side;
b. one or more shoulder straps coupled to the body and configured to be worn on a shoulder of a user;
c. a USB charging port for receiving a USB cable integrated within one of the one or more shoulder straps; and
d. a power bank connected to the USB charging port and for charging an electronic device coupled to the USB charging port through a USB cable.

2. The wearable shoulder bag of claim 1, wherein the shoulder bag comprises a back pack.

3. The wearable shoulder bag of claim 1, wherein the power bank is located within one of the one or more shoulder straps.

4. The wearable shoulder bag of claim 1, wherein the power bank is located within the body of the wearable shoulder bag.

5. The wearable shoulder bag of claim 1, wherein the power bank is removable.

6. The wearable shoulder bag of claim 1, wherein the power bank is located within a pocket of the body of the wearable shoulder bag.

7. The wearable shoulder bag of claim 1, wherein the body comprises one or more of a tool pocket and chain webbing for holding one or more tools.

8. The wearable shoulder bag of claim 1, wherein the body comprises a cover for covering the USB charging port when not in use.

9. A wearable bag comprising:
a. a body comprising a top side, a bottom side, a right side and a left side, wherein the body is openable from one or more of the top side, the bottom side, the right side and the left side; and
b. a power bank integrated within the body, the power bank configured for charging an electronic device.

10. The wearable bag of claim 9, wherein the wearable bag comprises a back pack.

11. The wearable bag of claim 9, wherein the power bank is located within a shoulder strap of the wearable bag.

12. The wearable bag of claim 9, wherein the power bank is removable.

13. The wearable bag of claim 9, wherein the power bank is located within a pocket of the body.

14. The wearable bag of claim 9, wherein the body comprises one or more of a tool pocket and chain webbing for holding one or more tools.

15. The wearable bag of claim 9, wherein the power bank removably couples with a charging cord for charging the electronic device.

16. The wearable bag of claim 9, wherein the power bank is charged by removably coupling a power cord to an inlet port of the power bank.

17. The wearable bag of claim 9, wherein the wearable bag comprises a solar panel for charging the power bank.

18. A shoulder strap for a wearable bag comprising:
a. a shoulder strap body; and
b. a power bank integrated within the shoulder strap body, the power bank configured for charging an electronic device.

19. The shoulder strap of claim 18, comprising a USB charging port for charging an electronic device through a USB cable.

20. The shoulder strap of claim 19, wherein the power bank is located within a pocket of the shoulder strap and connects to the USB charging port through interior circuitry of the body.

21. The shoulder strap of claim 20, wherein the power bank is removable from the pocket of the shoulder strap.

22. The shoulder strap of claim 18, wherein the power bank is sewed into the shoulder strap and is recharged while coupled within the shoulder strap.

23. The shoulder strap of claim 18, wherein the shoulder strap removably couples with a wearable shoulder bag.
